(19) United States
(12) Patent Application Publication
(10) Pub. No.: US 2003/0179075 A1
(43) Pub. Date: Sep. 25, 2003

(54) Property access system

(76) Inventor: Herbert A. Greenman, Palo Alto, CA (US)

Correspondence Address: Jeffrey P. Calfa, 954 Rice Court, Naperville, IL, 60565, US

(21) Appl. No.: 10/350,758

(22) Filed: Jan. 24, 2003

Related U.S. Application Data
(60) Provisional application No. 60/351,699, filed on Jan. 24, 2002.

(51) Int. Cl. H04B 1/00; G06K 19/00

(52) U.S. Cl. 340/5.54; 340/5.73

(57) ABSTRACT

A property access system that uses a computer system to generate an unlocking code that is unique for the person seeking access and/or the date and time of access, and a lock apparatus, possibly portable, that utilizes the unlocking code to provide access. The portable lock can be used in a lockbox configuration to allow access to contents inside the box, such as a mechanical key and information. In a lockbox configuration the lockbox has a doorknob shackle and a compartment that holds a key that allows the user to enter a property. The code used to access the key compartment is only good for an interval of time such as 15 minutes or a day. Each lock has a serial number, a clock, a unique encryption key, and an encryption algorithm to calculate the acceptable access codes for a specific time. The lock owner and a central facility have the same encryption algorithm and encryption key to calculate the entry code for a specific time.

This is a patent issuing from a non-provisional patent application claiming the priority of provisional patent application Serial No. 60/351,699, filed Jan. 24, 2002.

### BACKGROUND

This invention relates to systems controlling access to property such as real estate. This invention is directed to allowing access to property that may be used by many different people at different times. The objective is to allow only specific people access to the property only at authorized times. People who have accessed the property in the past do not have access to the property at a later time unless given authorization for the new time period. The advantages of this are that the lock changes the combination automatically by itself and the user does not need to obtain a special physical device to access the property. This provides a much higher degree of security than other systems on the market. The system also gives the capability of tracking who accessed the property and when.

This invention can be directed to showing real estate property where many agents and contractors need to access the property but only at specified times. It also may be directed to community sharing devices that can be used by many different people at different times such as rental cars that can be scattered at different places in the city.

More specifically, the invention involves a property access system that uses a computer system to generate an unlocking code that is unique for the person seeking property access and/or the date and time of access, and a lock apparatus, possibly portable, that utilizes the unlocking code to provide access to the property.

### PRIOR ART

Typically to gain access to locked property a person must be given a physical means such as a mechanical key to open the lock. In this case the person must return the physical device when done using the property or for someone else to use it.

Another method is to use a mechanical or electronic combination lock. This way the user does not need to get a physical device to open the lock. The problem is that someone must then physically or through some communication device change the combination so the previous user no longer has access. In many cases the locks are in temporary places where it will be hard set up practical ways of communication with the lock. A means to keep track of the use of the property is also needed.

What is needed is a locking system whose combination is only good for a specified time interval for a specified user and each user must get a new authorized code to enter at a different time period.

### SUMMARY

An objective of the invention is to provide a locking system whose combination is only good for a specified time interval for a specified user and each user must get a new authorized code to enter at a different time period.

A general objective of the invention is to provide a portable electronic lock that can only be opened by authorized persons during a specified time period and be able to keep track of who is scheduled to use the property. The lock itself holds information of when the lock was accessed, and if an agent code is used, the agent code. With multiple combinations for a specific time period one can differentiate different users during a specific time period. Using an agent code only allows access to the specific agent who knows the entry code and agent code.

The property access system of this invention satisfies all these objectives. The property access system uses a computer system to generate an unlocking code that is unique for the person seeking access and/or the date and time of access, and a lock apparatus, possibly portable, that utilizes the unlocking code to provide access. The portable lock can be used in a lockbox configuration to allow access to contents inside the box, such as a mechanical key and information. In a lockbox configuration the lockbox has a doorknob shackle and a compartment that holds a key that allows the user to enter a property. The code used to access the key compartment is only good for an interval of time such as 15 minutes or a day. Each lock has a serial number, a clock, a unique encryption key, and an encryption algorithm to calculate the acceptable access codes for a specific time. The lock owner and a central facility have the same encryption algorithm and encryption key to calculate the entry code for a specific time. A user can get the entry code by using the software, or with proper identification access a central facility through means such as a telephone, computer program, Internet, or wireless, and optionally with the added security of working only with the requesting user's personal identification code. The lock can store data of when it was accessed. The computer system can store and report data of who was given the access code for any time. The lock has the ability to allow multiple access codes and to store access codes that do not change with time for better access tracking. The lock will open and/or data can be transferred by using the attached keyboard or by using an external device that will enter the code to open the compartment. The external device can be a stand alone component working with some other component such as a pocket sized computer or cellular phone. The code to open the shackle is independent of the code to open the key compartment. An essentially unlimited amount of data can be transferred to or from the lockbox using the encryption algorithm.

There is also the possibility of storing codes (via hardware sync in cradle or transmitted via wireless) in a user's PDA before going to the lockbox and using it with IR, RF, or BlueTooth. In this manner it can be used for renting cars, Segways™, bicycles, or other devices that may be rented.

The lock of the property access system uses standard electrical/mechanical latches that are normally used in the industry. This invention utilizes electronics and algorithms to enable the latches and computer programs to generate access codes for the users. It enables techniques to get the access codes to devices that can communicate and open the lock and obtain the stored record of access times and access codes used to open the lock. The invention also can keep track of who is authorized to access the lock at any time.

The basic circuit is a microprocessor or any logical device that can store an algorithm.

A computing device uses an encryption algorithm to generate access codes using an encryption key that is unique for the lock and user, and using the date/time as an input code. The size of the access code is dependent on how much security and how much information needs to be embedded in the code. The lock evaluates the encryption code using the current date/time allowed to determine whether to open the lock. Multiple access codes can be generated for specific date/times.

The computer that generates the access code for the users also stores the user and the access code so reports can be generated of who is scheduled to access any lock at any date/time. The lock stores the date/time and the access code and optionally the agent code entered at that date/time so reports can be generated of actual lock use.

Access in the real estate business would be provided to agents, but could also be provided to service people, etc. through the same mechanism under control of the homeowner. The owner could be allowed to have access with a specific code number or could be allowed to change the code number for their personal use.

The showing agent could also be the listing agent in the case of attended showings. This provides security that the listing agent is only getting access to the property at owner approved times. It provides an additional level of security for the brokerage and removes the need for the listing agent to be carrying the key around to show the house. It provides some measure for the agent to assure the homeowner that the property was only accessed at the designated times. A narrow time window within which the lock is opened and the key can be used reduces the likelihood that the key could be copied.

One other use would be in a house or other facility's security system. The alarm could be turned off for the designated time specified according to this algorithm. This may be a significant other use of the system for houses that have security systems for security companies that incorporate this capability.

### BRIEF DESCRIPTION OF THE DRAWINGS

The novel features believed characteristic of the invention are set forth in the appended claims. The invention itself however, as well as a preferred mode of use, further objects and advantages thereof, will best be understood by reference to the following detailed description of an illustrative embodiment when read in conjunction with the accompanying drawings, wherein:

FIG. 1a shows a first embodiment of physical configuration of the lock of a property access system made in accordance with this invention.

FIG. 1b shows a second embodiment of physical configuration of the lock of a property access system made in accordance with this invention.

FIG. 2 shows a schematic of the components of one embodiment of a lock of a property access system made in accordance with this invention.

FIG. 3 is a flow chart showing an example of steps to generate an entry code good for up to four consecutive periods of access to a property through a lock made in accordance with this invention.

FIG. 4 is a flow chart showing an example of steps to open a lock made in accordance with this invention using an entry code good for up to four consecutive periods of access to a property.

FIG. 5 is a perspective view of a structure with a property access system made in accordance with this invention.

### DETAILED DESCRIPTION OF THE INVENTION

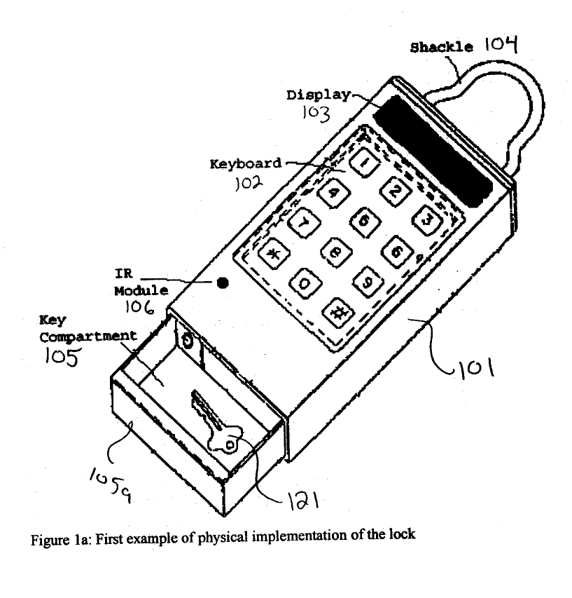

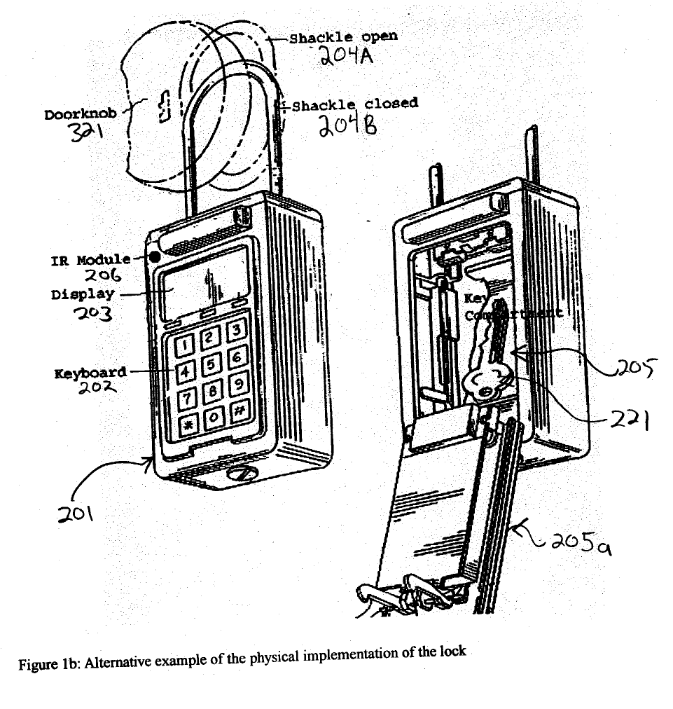

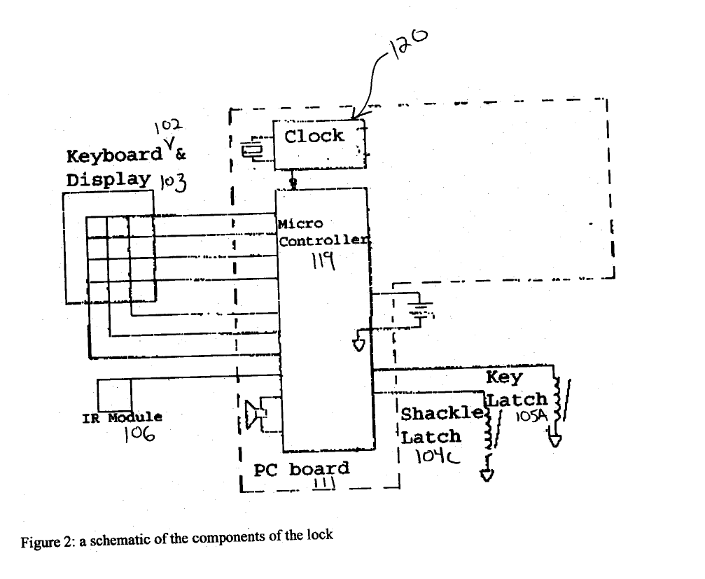

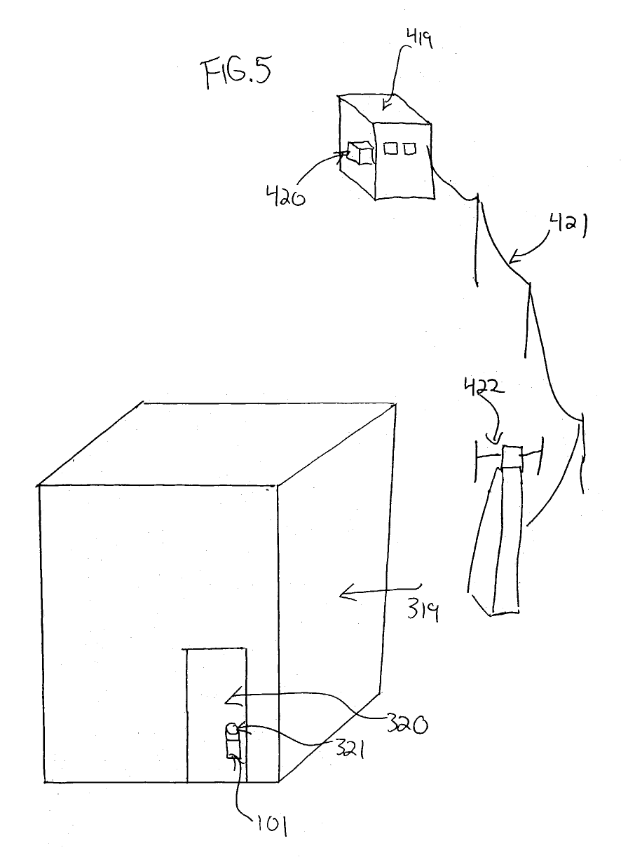

The property access system of this invention can be the lock unit and a parallel operating external code generating system. The locks may be of various types. FIGS. 1a and 1b illustrate two variations of locks that once programmed are examples of locks of this invention. The internal electronics of the two type locks is shown in one embodiment in FIG. 2. FIG. 1a provides a perspective view of a first example lock 101. The first lock 101 has a drawer type key compartment 105. A drawer 105a defines the key compartment 105 and is for holding a key such as key 121 shown in the key compartment 105. The key 121 may be any unlocking mechanism or starting mechanism such as a standard metal or plastic key as well as an access card with a magnetic strip or embedded chip. We have provided FIG. 5 to demonstrate the uses of property access system for controlling access to a property 319. The property 319 has a door 320 in which the key 121 may be used to access the interior of the property 319. Although the property shown is real estate property, the property may be a mobile vehicle also. When the property 319 is real property, the lock 101 is commonly referred to as a lockbox. The lock 101 may be engaged to the doorknob 321 of the door through a shackle 104. The first lock 101 has a information input device 102 which in the example shown is a keyboard 102. The information input device 102 may be another device for inputting an access code to open the drawer 105a. An infrared (IR) sensing module 106 may be included in the lock 101 for accepting an access code input from an external IR communication device and in this mode the IR module would be the information input device. The lock 101 may have a display 103 to provide status to a user of the lock 101 or to simply let the user know which numbers he or she has entered. The shackle 104 may be code driven to allow it to be engaged or disengaged.

We have provided a second lock 201 to demonstrate another example. The second lock 201 also is shown with a keyboard 202 for accepting access codes. Also there is a display 203 to provide the status of the lock 201. There is a shackle 204 shown in an open shackle 204A position and a closed shackle 204B. The open shackle 204A position is used to engage the lock 201 to the doorknob 321 and the closed shackle 204B position is used to show the lock 201 engaged to the doorknob 321. There is a key compartment 205 that is accessed through a door 205a, which swings open or closed to allow access to a key 221 in the key compartment 205. The second lock 201 also may have an IR sensing module 206 for accepting an access code in lieu of a keyboard 202.

One embodiment of the internals of the lock 101 is shown in FIG. 2. This internal embodiment could also apply to the lock 201. The algorithm for generation of specific access codes is loaded on a controller 119 such as a micro-controller 119. There may be an external or internal clock 120 for generating time sensitive access codes that may only be used within specific time intervals. The keyboards 102 and 202 may communicate with the controller through hard wiring as shown or by wireless communications protocol such as IR or Blue Tooth technology. The IR module 106, where used is in communication with the controller 119. The controller 119 and clock 120 are part of a PC board 111. The micro-controller 119 may provide open communications to open the key compartments 105 and 205; and to open the shackles 104 and 204.

As mentioned above, there is a series of steps or algorithm that are loaded onto the controller 119 of the locks 101 and 201. This same algorithm or series of steps must also operate on a separate parallel operating external code generating system or computer 420. This computer generates the same specific access codes for the times as the locks 101 and 201. In this way, a person needing to access the property 319 may request the access code for a particular time the property 319 may be accessed either directly or indirectly from the parallel access code generating system 420. The parallel code generating system 420 may be at brokerage office or a central facility 419. The parallel code generating system 420 may be accessed via landlines (the Internet or phone) 421 or wireless technology 422.

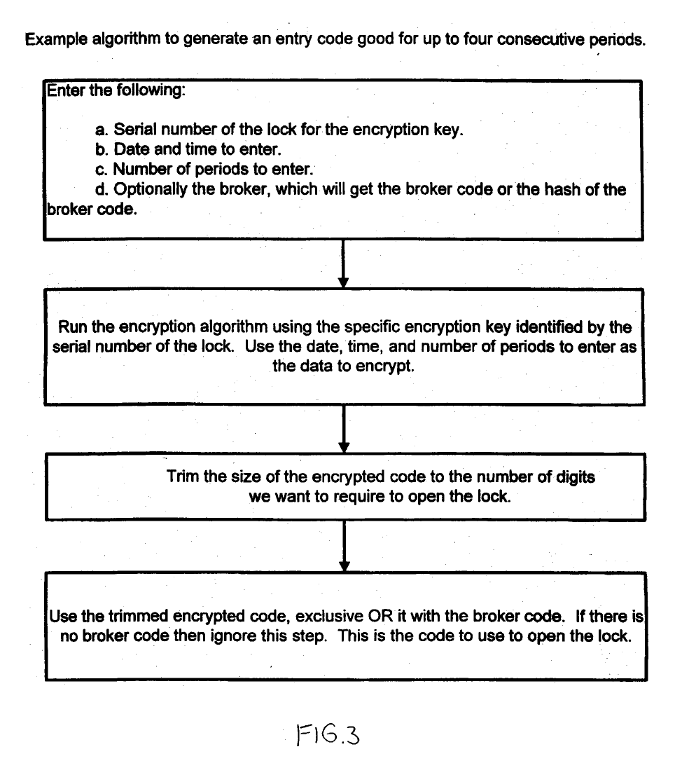

The controller 119 of the locks 101 and 201 and the parallel access code generating system 420 act to generate entry access codes for particular time periods. A sample set of access code generating steps is shown in FIG. 3. The input data entered includes the specific serial number to identify the particular lock 101 or 201. Creating an encryption code for the date, time, and periods of availability that is needed. Additionally, the encryption code is trimmed to the desire number of digits. In the embodiment shown, there is a requirement to also tie the code to a specific broker or person to access the property 319. The controllers 119 and the parallel access code generating system 420 create the access code by exclusive ORing it with the broker code. When a specific person is to be tied to the access of the property 319, there are multiple ways to make part of the access code to include the reference to the specific person or broker who will access the property. Exclusive ORing is just one method. Another method could be to make some of the digits of the access code be the specific person identifier and the other part be an encrypted computer generated key number. Another method would be to simply add the absolute value of the specific person identifier to the encrypted computer generated key number.

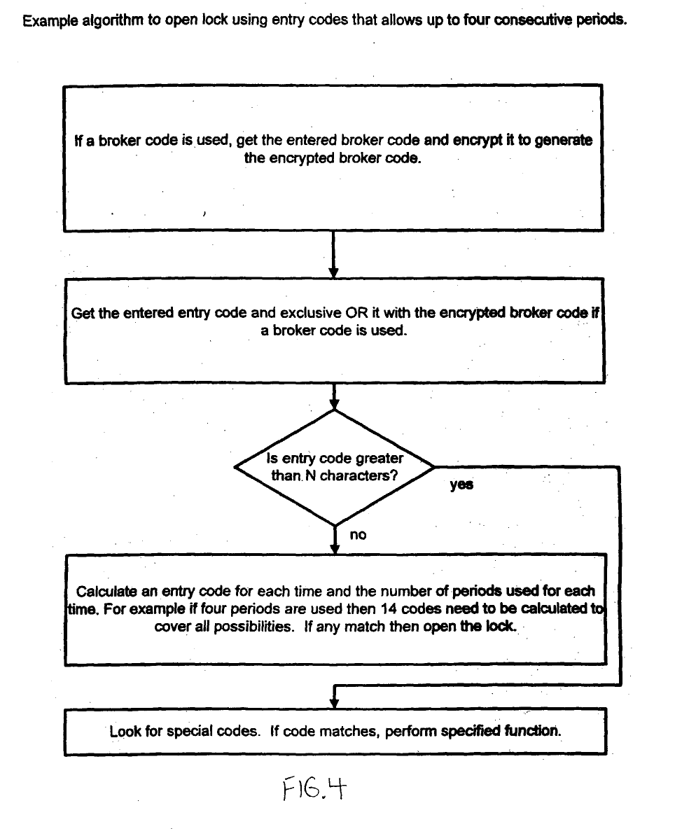

When a person or broker attempts to access a property, that person will enter the access code to open the lock. If the lock 101 or 201 is being used in the lockbox mode, then the key 121 will be accessed in the key compartment 105 or 205. The key 120 will then be used to access the door or portal 320. One embodiment of steps of opening a lock 101 or 201 is shown in FIG. 4. A broker will add his or her broker code and an encrypted broker code will be generated. The entered entry code is acquired, then in the exclusive OR embodiment the entry code is exclusive ORed with the encrypted entry code. The controller determines if the entry or access code has the right number of digits. If it does, than the system looks to match the code with the correct encrypted code for the date, and time. If there is a match the lock is opened by way of signal from the controller 119. If the entry code does not have the correct number of digits, the system checks to see if the entry code matches a special code (e.g. the backdoor code); if so, it performs the function specified by the entry code.

The locks may be used by individuals who use one or many locks and may be used by members of large associations that need to keep track of different locks that belong to different groups and individuals and allow different levels of access to different groups.

For individuals to generate access codes a computer program may be installed on a computer that uses algorithms to generate the access codes and generates reports of users scheduled to access the locks. An example was discussed above and shown in FIG. 3. The computer program has a user interface that allows the user to enter a user, which lock, and a time to generate an access code. The access code is displayed on the screen and the user has the choice of communicating the access code to another person's computer or device that they can use to open the lock. This communication can also include Internet access, web access, email, voice, and voicemail. The program stores the information and can generate reports or interface to other programs to store the data and/or generate reports.

For larger groups and associations the program that generates the code can have sophisticated central computer 420 features to authenticate the users, get information from the users, and send the access codes to the users. Communication to the central computer 420 can be through Internet access, web access, voice, email, wired, and wireless network communications. Authentication includes keying in passwords, codes from the special devices, and biometrics. Information exchange can range from special devices communicating through sophisticated networks down to simple exchange through conversation. The central computing center also stores the data so reports can be generated to groups, individuals, and other interested parties.

The computer uses a generally secure encryption program that is commercially available. The computer puts the GMT (Greenwich Mean Time) date/time and any other data for the input to the key generation algorithm. The data can be information such as the time interval that this code is intended to open the lock. The computer program then uses the serial number associated with the lock to identify the appropriate encryption key. It uses the encryption key and the input data to generate an access code that can then be sent to the authorized user. A subset of the generated key is used as the code to open the lock.

The system can provide each agent with a private code that they enter into the lockbox along with the code; by default the code can be 0 if the agents do not want this security. The combination to unlock can be an exclusive OR encryption of the agent code and the code that would otherwise be used to unlock the lock. The agent can change their agent code on a secure web site and the agent can be immediately disabled at the secure web site. Any properties 319 that they already have the code to access would, of course, still work the way prior to their changing their code. This provides better security and accountability since the agent would have to have their private number to be able to open the lock. It would require entering more digits, but it is the same number each time that they enter so it is easier to remember. There is an advantage of a central administration system rather than something that is only at the brokerage office. This provides additional security since even the office manager does not have the code to get in because the code given must work in conjunction with a valid agent code. This provides additional security protection for the office in control over the information to have access to homes since they do not have to assume the responsibility of the people working there knowing the code to enter.

The locks 101 or 201 uses a controller 119 or an electronic device 119 that can store algorithms and generate an output that can either directly or indirectly open the latch. A current implementation is the use of a micro controller 119 with an embedded real time clock, I/O pins for the communication device and output pins to drive the logic to open the electronic latch. The communications device can be any of a direct wire, sound, IR, RF, or other protocol implementations such as Bluetooth. The current version uses a direct connection to a keyboard 102 or 202, a serial connection to an LCD display 103 or 203, and an output latch that connects to a transistor that connects to the electromechanical lock. The keyboard 102 or 202 and LCD 103 or 203 can be replaced, or integrated with other communication means just mentioned.

The microprocessor 119 reads the agent code, if it is entered, and the encrypted access code entered by the user. It then encrypts the agent code. An exclusive OR is performed between the encrypted agent code and the entered encrypted access code to generate the new encrypted access code. The lock 101 or 201 then internally generates the allowable access codes for the current time period using a similar process as the computer 420 that generates the access codes and compares them with the new encrypted access code. If an access code matches the encrypted access code, it opens the latch and records the access code and time of entry to be accessed by the lock owners.

A special code is available for each lock, a back door, which allows the lock parameters to be changed. This can be used to disable a specific appointment.

Note that time intervals may be set to something like 5 minutes to allow flexible construction of business rules for a particular installation.

Specifically, the algorithm to determine whether to open the lock operates as follows:

The encryption algorithm for the lock's key is run for all GMT date/times that have a time interval that would allow access. The appropriate subset of these codes that would be entered for access is compared to the actual code entered. If any of these matches, then the lock is opened. The following example illustrates this:

Assume local convention for users of the portable lock system is:

The time intervals are 15 minutes.

The user is permitted to request from 1 to 4 time intervals for the appointment (15 minutes to 1 hour).

They may be up to 1 time interval early or late for the appointment.

There is to be less than one chance in 1 million of guessing the entry code.

Three tries are allowed before the system shuts down for a longer period of time.

Assume a user:

Requests access for Jan. 1, 2001 at 10:00 AM

They want a 1/2 hour appointment.

The central computer 420 would use this date/time value and an interval count of 2 as input to the encryption algorithm; it would use the key corresponding to the serial number of the lock 101 or 201 to be opened to generate the encrypted code. The entry code would be the final 8 digits of the encrypted code exclusive OR'd with the encrypted version of the agent code if the agent code is used.

If the user arrives at 9:55 AM on Jan. 1, 2001, the user enters the agent code if used, then the enter key, the 8 digit code into the lock, and the enter key. If the lock uses an agent code, it computes the truncated encrypted version of the agent code and exclusive Or's it with the 8 digit code. The lock would compute possible entry codes for that date for the following combinations:

9:00 AM and 4 intervals (60 minutes)

9:15 AM and 3 or 4 intervals (45 or 60 minutes)

9:30 AM and 2, 3, or 4 intervals (30, 45, or 60 minutes)

9:45 AM and 1, 2, 3, or 4 intervals (15 to 60 minutes)

10:00 AM and 1, 2, 3, or 4 intervals (15 to 60 minutes)

Note that the user can arrive anywhere from 9:45 AM to 10:45 AM and gain entry since they can arrive 15 minutes early or late and they can arrive anywhere in the 1/2 hour after the starting time.

If any of those 14 access codes were the same as the one entered, then the lock 101 or 201 would open. 8 digits were required for the access code since there are 14 possible values that can open the lock and 3 attempts are allowed before the lock is disabled in a given time interval. 108 over the product of 14 times 3 is 2,380,952 hence less than 1 chance in 1 million of guessing an access code (7 digits would only give 1 chance in 238,809 of guessing an access code and hence is not enough).

External devices other than the keyboard 102 and LCD display 103 can access or communicate with the lock 101 or 201. This means the user can use their own device to store access codes and does not have to punch in numbers at the site. The user device can be a smart cell phone, a pocket sized computer, a special device for just this purpose, or any device that can communicate physically through the IR, RF (radio waves), etc. interface and understand the same protocol as the lock 101 or 201. These devices can either have the access codes punched in manually ahead of time or can communicate with the call centers communication options and automatically receive and store the access codes for use at each site.

The lock owner can also communicate with the device to detach it from its current location and to receive the data stored in the lock.

Alkaline, lithium batteries, fuel cells, or other technologies that have a long life and work at low temperatures may power the lock 101 or 201. A low battery indicator shows when the expected use will be about another month. The lock 101 or 201 has external contacts for an external battery in case the lock has not been used for a very long time or has been abused in a way to ruin the internal batteries. There can be a recharging mechanism on the lock 101 or 201, such as a solar panel. Alternatively, mechanical energy can be converted to electrical energy to power the lock.

The property access system may include the following characteristics. An electronic circuit 119 with a calendar and clock 120 that uses an algorithm to calculate access codes for operating an electromechanical lock. The algorithm may use the GMT date/time so the access codes are only useable for a specified time interval for the date selected. Each lock 101 or 201 may allow multiple access codes. The time interval can be part of the access codes. If the time interval is always the same, only the start date/time need to be used to determine the access codes. Each lock 101 or 201 has an electronically embedded serial number.

Each lock 101 or 201 is given a unique encryption key that may or may not be changeable. The encryption algorithm can be any of several available, for example for simplicity the standard, extended DES, or AES encryption standard.

The electronic circuit 119 has the option of any or all of the following connections. The circuit may be direct wired decoding of the keyboard using standard parallel or serial connections. There may be direct wiring of other types of input devices that can be decoded such as switches and potentiometers. There may be wiring of the above externally through contacts.

Components may be engaged through wireless connections such as a coil, sound, IR, or RF. These wireless connections may use modern communication protocols such as limited range wireless and wireless LANs.

Depending on the connections, a user can use compatible devices to communicate the access code with the lock. These devices include cell phones, portable computing devices, special custom devices, or other devices where the user can store and transmit the access code to open the lock. If the devices do not come standard with a means of communicating with the lock, optional add-ons may be available to enable communication. If the user does not have a special device, the lock has the capacity to have a built in input device.

The lock 101 or 201 can have the capability to record and store the time and access code each time the lock is used. Using security precautions this information can be retrieved by an external device that communicates with the lock. The lock algorithm can allow multiple access codes at any time period allowing more precise information to determine who may be using the lock at a certain time. The lock user can put in times that the lock cannot be opened.

The lock may have a low battery indicator. With modern batteries the lock will generally still be usable for a long time after low battery warning, most likely weeks and months. The lock may have external contacts for an external battery in case the internal battery is no longer working. Since this rare occurrence should only happen when the lock is essentially abused or abandoned; this is considered as a repair mode rather than an operation mode.

When used as a lock box there can be two separate latches with separate access codes for the latch that allows access to the key and the latch that allows it to be mounted to a stationary object such as a door using a shackle. The latch that mounts the lock may or may not have time sensitive access codes. An authorized user may change it.

A separate computer program may generate the access codes for the lock at a specific time period. This program generates the code for the lock owner who has the encryption key of the lock. The program is then password controlled or uses alternative authorization techniques. Once connected to the program a user interface makes it easy to choose a date and time to generate an access code. This code can be written down or communicated to an external portable computing device such as a cellular telephone or any portable device that can be programmed to communicate with the lock.

A central facility 419 can be setup so that users such as agents or contractors who need to enter can contact the facility 419 and get the access code for a specific time period. The central facility 419 has software that properly checks the authorization of the user before supplying the access code. Authorization can be through passwords or any of many biometric techniques. The central facility 419 can handle a large number of locks 101 or 201 and can generate usage reports for each user or group of users. The central facility 419 has options to be accessed through call centers, the Internet, wireless technologies, or other communication techniques. The call centers can be combinations of human operated to being fully automated with voice recognition and biometric technologies.

Other information can be transferred to or from the lock 101 or 201, for example to open the shackle 104 or 204 or to enable download or to transfer information. These functions could typically entail using a longer number entered into the lock that could be encrypted in a similar manner to the unlocking function.

Multiple safes can use the same decoding algorithm so that all could be unlocked with the same ID code and an unlock code that changes on a daily basis. This could be useful in car lots where multiple people need to have access to multiple safes throughout the day.

The locks may be portable.

The conventional electronic systems have required different physical keys for each multiple listing system (MLS) that a brokerage belongs to. Since this invention uses a code that is entered and hence does not require a physical key, it is better for brokerages that have properties in different MLSs. This is significant for many of the large brokerages.

Each agent can have a private code, changeable at any time, so the key given only works for the agent requesting the code and useless to the facility giving out the code or someone seeing the code if written down, received through the Internet, or other means of interception. An encrypted version of the agent code rather than the agent code itself can be stored in the central facility providing additional security for the agents' code.

As described above, the property access system provides a number of advantages, some of which have been described above and others of which are inherent in the invention. Also modifications may be proposed to the property access system without departing from the teachings herein.

We claim:

1. A property access system for controlling user access to a property that may be accessed with a key, comprising:
a lock;
said lock having an internal controller;
said internal controller engaged to a clock for receiving date and time data;
said lock having a key compartment for storage of the key to the property;
an information input device in communication with said internal controller;
said information input device for inputting user date and time period sensitive access codes;
said internal controller programmed to use said clock to generate a specific series of date and time sensitive access codes for defined periods of property access;
said internal controller programmed to allow opening of said key compartment only upon a user entering a date and time sensitive access code for a defined period of property access;
a parallel operating external code generating system programmed to generate said same specific series of date and time sensitive access codes for defined periods of property access as said internal controller of said lock; and
said parallel operating external code generating system programmed to provide a user with a user specific date and time sensitive access codes for a specific period within said defined period of property access so as to allow the user to access the key compartment of the lock only during said specific period of time.

2. The property access system of claim 1, comprising:
said internal controller of said lock programmed to record in a memory section said user time and date of entry into said key compartment upon entry of said date and time sensitive access code to allow tracking of specific user access to the property.

3. The property access system of claim 2, wherein:
said information input device is a keyboard in communication with said internal controller.

4. The property access system of claim 2, wherein:
said information input device is an IR transmitter in communication with said internal controller.

5. The property access system of claim 2, wherein:
said information input device is an radio wave transmitter in communication with said internal controller.

6. The property access system of claim 2, wherein:
said information input device is a Bluetooth protocol capable transmitter in communication with said internal controller.

7. The property access system of claim 2, comprising:
a shackle engaged to said lock for engagement of said lock to a door operator of the property as well as disengagement from the door of the property; and
said internal controller of said lock programmed to control engagement and disengagement of said shackle upon entry of a shackle control code through said information input device.

8. The property access system of claim 2, wherein:
said lock has a unique serial number;
said parallel operating external code generating system generates said specific series of date and time sensitive access codes for defined periods of property access as said internal controller of said lock unique to said lock; and
said parallel operating external code generating system separately tracks access codes for more than one unique lock by unique serial numbers.

9. The property access system of claim 8, wherein:
said parallel operating external code generating system may be accessed by a user remotely through the Internet to provide said user with specific date and time sensitive access codes to access said key compartment of said lock to access the property.

10. The property access system of claim 8, wherein:
said parallel operating external code generating system may be accessed by a user remotely through wireless communication devices to provide said user with specific date and time sensitive access codes to access said key compartment of said lock to access the property.

11. The property access system of claim 1, wherein:
said programming of said internal controller and said parallel operating external code generating system to generate a specific series of date and time sensitive access codes for defined periods of property access including the steps of:
accepting a unique serial number for said lock for an encryption key, as well as date and time to enter the property, number of periods to enter, and a user code;
creating a series of date and time sensitive unprocessed encryption codes for said defined periods using an encryption algorithm with a specific encryption key unique to said unique lock serial number;
trimming the size of said generated unprocessed encryption codes to a predetermined number of digits required to open said lock key compartment; and
creating a series of date and time sensitive access codes by combining said trimmed unprocessed encryption codes with the user code using an exclusive OR combination method.

12. The property access system of claim 11, wherein:
said programming of said internal controller to evaluate and validate specific series of date and time sensitive access codes for defined periods of property access to allow access to said key compartment, including the steps of:
encrypting a user code, if user code is used;
accepting entered access code and combining said entered access code with said encrypted user code using an exclusive OR technique;
comparing number of digits entered access code with predetermined number N of digits required to open said lock key compartment;
if said entered access code has more digits than N, then looking for special codes indicating special actions, and if an entered access code matches with a special action code, directing performance of said special action associated with the special action code; and
if said entered access code does not have more digits than N, then calculating an entry code for each time and date and a number of periods for each time, then comparing said entered access code with said calculated entry codes and if there is at least one match, with the calculated, allowing said key compartment to open.

13. A property access system for controlling user access to a property that may be accessed with a key, comprising:
a lock;
said lock having an internal controller;
said internal controller engaged to a clock for receiving date and time data;
said lock having a key compartment for storage of the key to the property;
an information input device in communication with said internal controller;
said information input device for inputting user date and time period sensitive access codes;
said internal controller programmed to use said clock to generate a specific series of date and time sensitive access codes for defined periods of property access;
said internal controller programmed to allow opening of said key compartment only upon a user entering a date and time sensitive access code for a defined period of property access;
a parallel operating external code generating system programmed to generate said same specific series of date and time sensitive access codes for defined periods of property access as said internal controller of said lock;
said parallel operating external code generating system programmed to provide a user with a specific date and time sensitive access codes for a specific period within said defined period of property access so as to allow the user to access the key compartment of the lock only during said specific period of time; and
a shackle engaged to said lock for engagement of said lock to a door operator of the property as well as disengagement from the door of the property; and
said internal controller of said lock programmed to control engagement and disengagement of said shackle upon entry of a shackle control code through said information input device.

14. The property access system of claim 13, wherein:
said lock has a unique serial number;
said parallel operating external code generating system generates said specific series of date and time sensitive access codes for defined periods of property access as said internal controller of said lock unique to said lock; and
said parallel operating external code generating system separately tracks access codes for more than one unique lock by unique serial numbers.

15. The property access system of claim 14, wherein:
said parallel operating external code generating system may be accessed by a user remotely through the Internet to provide said user with specific date and time sensitive access codes to access said key compartment of said lock to access the property.

16. The property access system of claim 14, wherein:
said parallel operating external code generating system may be accessed by a user remotely through wireless communication devices to provide said user with specific date and time sensitive access codes to access said key compartment of said lock to access the property.

17. The property access system of claim 14, wherein:
said programming of said internal controller and said parallel operating external code generating system to generate a specific series of date and time sensitive access codes for defined periods of property access including the steps of:
accepting said unique serial number for said lock for an encryption key, as well as date and time to enter the property, number of periods to enter, and a user code;
creating a series of date and time sensitive unprocessed encryption codes for said defined periods using an encryption algorithm with a specific encryption key unique to said unique lock serial number;
trimming the size of said generated unprocessed encryption codes to a predetermined number of digits required to open said lock key compartment; and
creating a series of date and time sensitive access codes by combining said trimmed unprocessed encryption codes with the user code using an exclusive OR combination method.

18. A property access system for controlling user access to a property that may be accessed with a key, comprising:
a lock;
said lock having an internal controller;
said internal controller engaged to a clock for receiving date and time data;
said lock having a key compartment for storage of the key to the property;
an information input device in communication with said internal controller;
said information input device for inputting user date and time period sensitive access codes;
said internal controller programmed to use said clock to generate a specific series of date and time sensitive access codes for defined periods of property access;
said internal controller programmed to allow opening of said key compartment only upon a user entering a date and time sensitive access code for a defined period of property access;
a parallel operating external code generating system programmed to generate said same specific series of date and time sensitive access codes for defined periods of property access as said internal controller of said lock;
said parallel operating external code generating system programmed to provide a user with a user specific date and time sensitive access codes for a specific period within said defined period of property access so as to allow the user to access the key compartment of the lock only during said specific period of time;
said internal controller of said lock programmed to record in a memory section said user time and date of entry into said key compartment upon entry of said date and time sensitive access code to allow tracking of specific user access to the property;
a shackle engaged to said lock for engagement of said lock to a door operator of the property as well as disengagement from the door of the property; and
said internal controller of said lock programmed to control engagement and disengagement of said shackle upon entry of a shackle control code through said information input device;
said lock has a unique serial number;
said parallel operating external code generating system generates said specific series of date and time sensitive access codes for defined periods of property access as said internal controller of said lock unique to said lock; and
said parallel operating external code generating system separately tracks access codes for more than one unique lock by unique serial numbers.

19. The property access system of claim 18, wherein:
said programming of said internal controller and said parallel operating external code generating system to generate a specific series of date and time sensitive access codes for defined periods of property access including the steps of:
accepting a unique serial number for said lock for an encryption key, as well as date and time to enter the property, number of periods to enter, and a user code;
creating a series of date and time sensitive unprocessed encryption codes for said defined periods using an encryption algorithm with a specific encryption key unique to said unique lock serial number;
trimming the size of said generated unprocessed encryption codes to a predetermined number of digits required to open said lock key compartment; and
creating a series of date and time sensitive access codes by combining said trimmed unprocessed encryption codes with the user code using an exclusive OR combination method.
